(19) United States
(12) Patent Application Publication
(10) Pub. No.: US 2025/0350416 A1
(43) Pub. Date: Nov. 13, 2025

(54) QUASI-CO-LOCATION BETWEEN DEMODULATION REFERENCE SIGNAL PORTS AND REFERENCE SIGNALS DURING FREQUENCY COMPENSATION

(71) Applicant: QUALCOMM Incorporated, San Diego, CA (US)

(72) Inventors: Min HUANG, Beijing (CN); Jing DAI, Beijing (CN); Chao WEI, Beijing (CN)

(21) Appl. No.: 18/854,281

(22) PCT Filed: May 20, 2022
(86) PCT No.: PCT/CN2022/094098

§ 371 Date: Oct. 4, 2024

(51) Int. Cl. H04L 5/00; H04L 27/26

(52) U.S. Cl. CPC H04L 5/0026; H04L 5/0044; H04L 27/261

(57) ABSTRACT

Various aspects of the present disclosure generally relate to wireless communication. In some aspects, a user equipment (UE) may receive an indication of whether one or more first demodulation reference signal ports are delay-related validly quasi-co-located with one or more first reference signals based on frequency compensation performed by a network. Accordingly, the UE may receive data on a physical downlink shared channel based at least in part on the indication. Numerous other aspects are described.

### FIELD OF THE DISCLOSURE

Aspects of the present disclosure generally relate to wireless communication and to techniques and apparatuses for quasi-co-location between demodulation reference signal ports and reference signals during frequency compensation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of whether one or more first demodulation reference signal (DMRS) ports are delay-related validly quasi-co-located (QCL'd) with one or more first reference signals based on frequency compensation performed by a network. The method may include receiving data on a physical downlink shared channel (PDSCH) based at least in part on the indication.

Some aspects described herein relate to an apparatus for wireless communication at a UE. The apparatus may include a memory and one or more processors coupled to the memory. The one or more processors may be configured to receive an indication of whether one or more first DMRS ports are delay-related validly QCL'd with one or more first reference signals based on frequency compensation performed by a network. The one or more processors may be configured to receive data on a PDSCH based at least in part on the indication.

Some aspects described herein relate to a non-transitory computer-readable medium that stores a set of instructions for wireless communication by a UE. The set of instructions, when executed by one or more processors of the UE, may cause the UE to receive an indication of whether one or more first DMRS ports are delay-related validly QCL'd with one or more first reference signals based on frequency compensation performed by a network. The set of instructions, when executed by one or more processors of the UE, may cause the UE to receive data on a PDSCH based at least in part on the indication.

Some aspects described herein relate to an apparatus for wireless communication. The apparatus may include means for receiving an indication of whether one or more first DMRS ports are delay-related validly QCL'd with one or more first reference signals based on frequency compensation performed by a network. The apparatus may include means for receiving data on a PDSCH based at least in part on the indication.

Some aspects described herein relate to a method of wireless communication performed by a network entity. The method may include transmitting an indication of whether one or more first DMRS ports are delay-related validly QCL'd with one or more first reference signals based on frequency compensation performed by the network entity. The method may include transmitting to a UE based on the indication.

Some aspects described herein relate to an apparatus for wireless communication at a network entity. The apparatus may include a memory and one or more processors coupled to the memory. The one or more processors may be configured to transmit an indication of whether one or more first DMRS ports are delay-related validly QCL'd with one or more first reference signals based on frequency compensation performed by the network entity. The one or more processors may be configured to transmit to a UE based on the indication.

Some aspects described herein relate to a non-transitory computer-readable medium that stores a set of instructions for wireless communication by a network entity. The set of instructions, when executed by one or more processors of the network entity, may cause the network entity to transmit an indication of whether one or more first DMRS ports are delay-related validly QCL'd with one or more first reference signals based on frequency compensation performed by the network entity. The set of instructions, when executed by one or more processors of the network entity, may cause the network entity to transmit to a UE based on the indication.

Some aspects described herein relate to an apparatus for wireless communication. The apparatus may include means for transmitting an indication of whether one or more first DMRS ports are delay-related validly QCL'd with one or more first reference signals based on frequency compensation performed by the network entity. The apparatus may include means for transmitting to a UE based on the indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4A is a diagram illustrating an example of non-coherent joint transmission (NCJT), in accordance with the present disclosure.

FIG. 4B is a diagram illustrating an example of coherent joint transmission (CJT), in accordance with the present disclosure.

FIG. 5 is a diagram illustrating an example associated with quasi-co-located transmission configuration indication states for communications between a network node and a UE, in accordance with the present disclosure.

FIG. 6 is a diagram illustrating an example associated with quasi-co-location (QCL) between demodulation reference signal (DMRS) ports and reference signals during frequency compensation, in accordance with the present disclosure.

FIG. 7A is a diagram illustrating an example associated with QCL between DMRS ports and reference signals during frequency compensation in CJT, in accordance with the present disclosure.

FIG. 7B is a diagram illustrating an example associated with QCL between DMRS ports and reference signals during frequency compensation in NCJT, in accordance with the present disclosure.

FIGS. 8 and 9 are diagrams illustrating example processes associated with QCL between DMRS ports and reference signals during frequency compensation, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

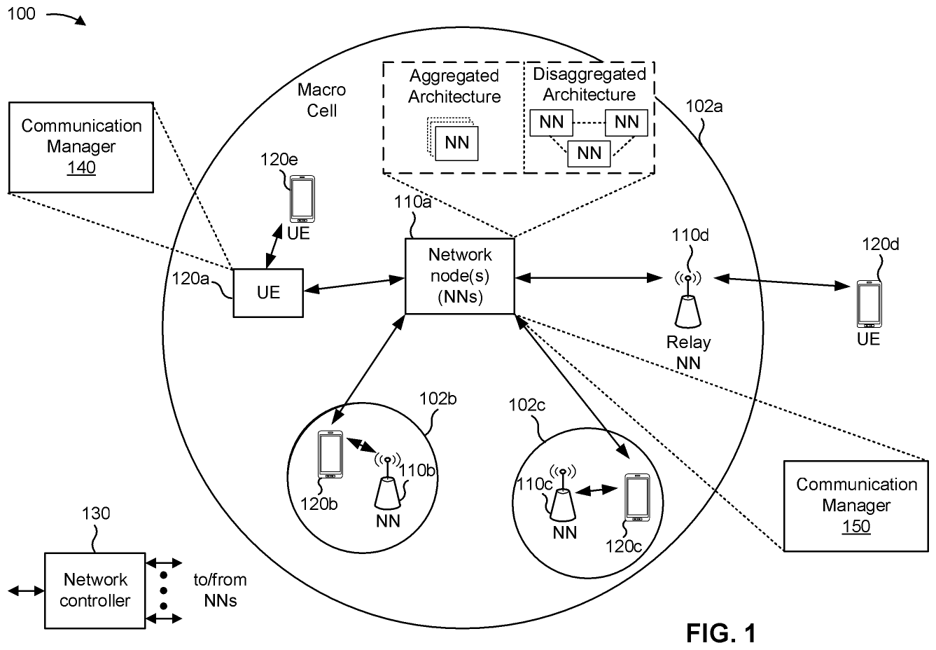

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of whether one or more first demodulation reference signal (DMRS) ports are delay-related validly quasi-co-located (QCL'd) with one or more first reference signals based on frequency compensation performed by a network and receive data on a physical downlink shared channel (PDSCH) based at least in part on the indication. Additionally, or alternatively, the communication manager 140 may perform one or more other operations described herein.

In some aspects, the network node 110 may include a communication manager 150. As described in more detail elsewhere herein, the communication manager 150 may transmit an indication of whether one or more first DMRS ports are delay-related validly QCL'd with one or more first reference signals based on frequency compensation performed by the network node 110 and transmit to the UE 120 based on the indication. Additionally, or alternatively, the communication manager 150 may perform one or more other operations described herein.

As indicated above, FIG. 1 is provided as an example. Other examples may differ from what is described with regard to FIG. 1.

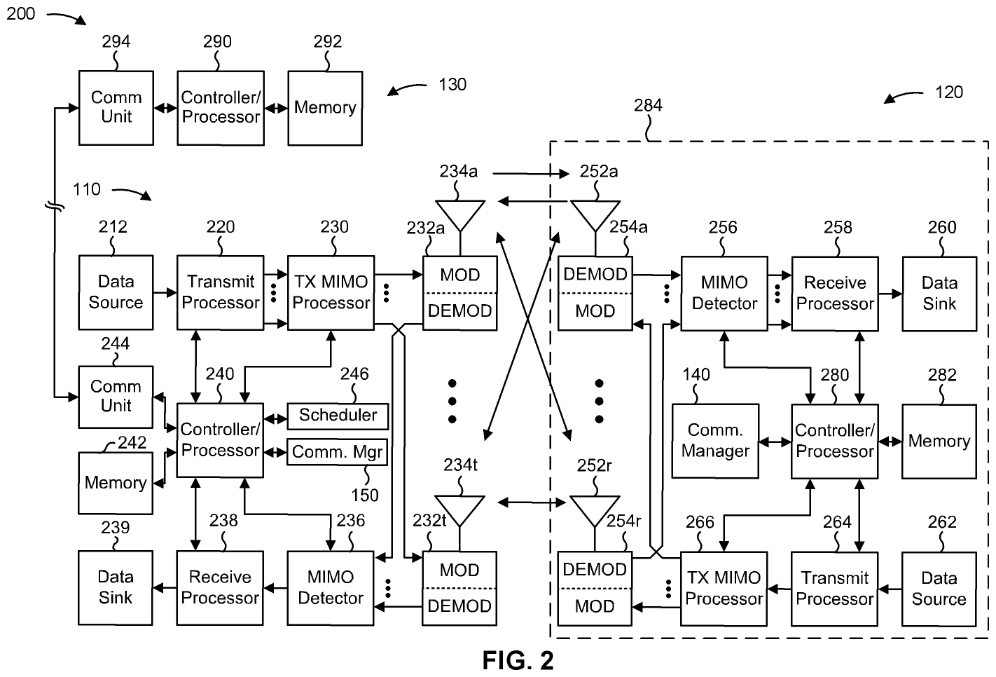

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

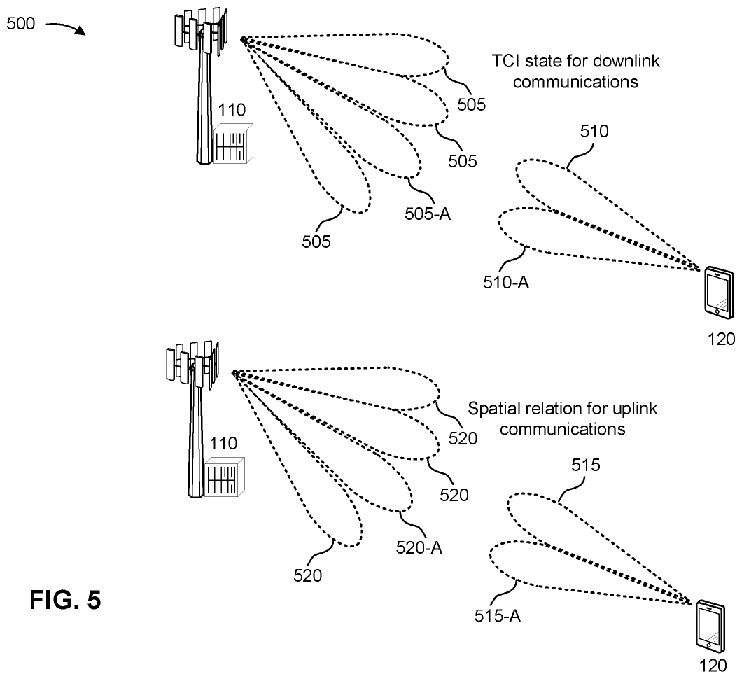

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

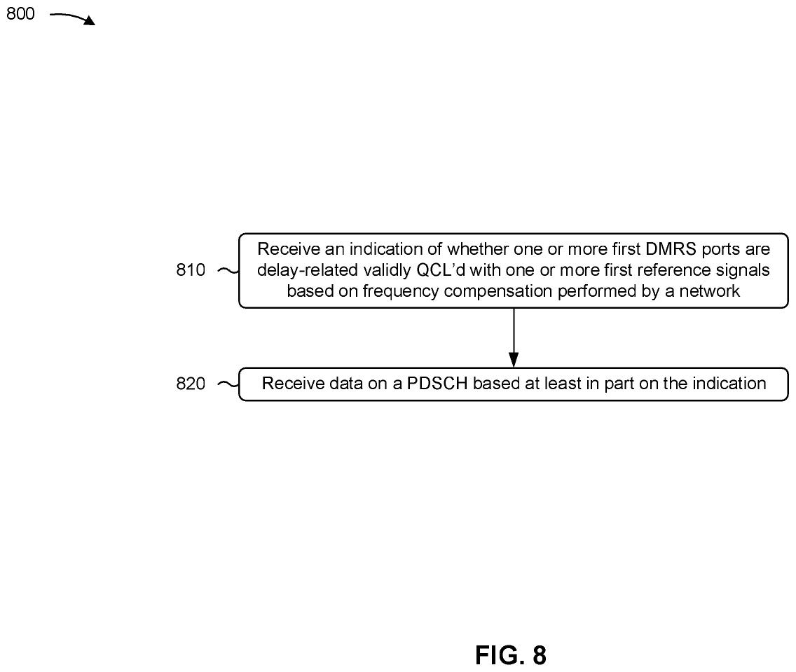

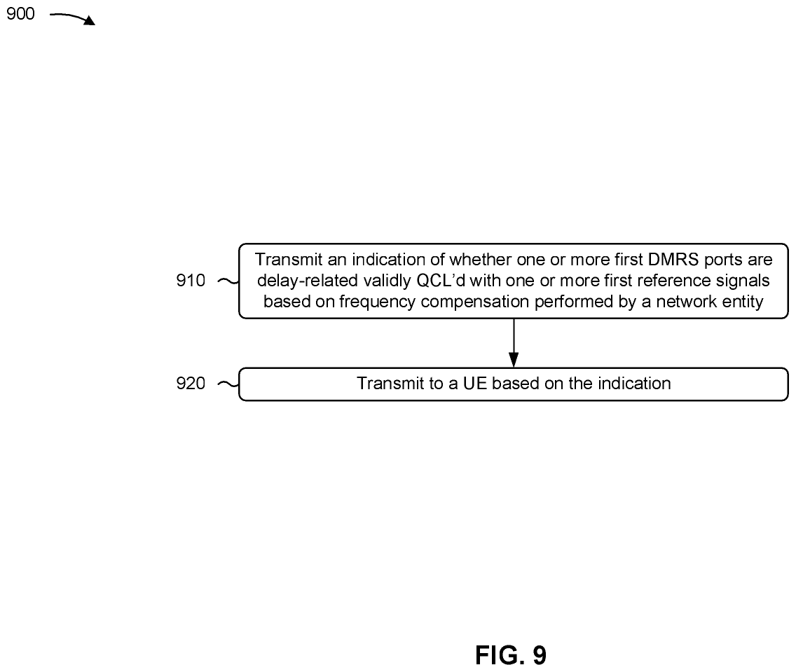

The controller/processor 240 of the network node 110, the controller/processor 280 of the UE 120, and/or any other component(s) of FIG. 2 may perform one or more techniques associated with quasi-co-location (QCL) between DMRS ports and reference signals during frequency compensation, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

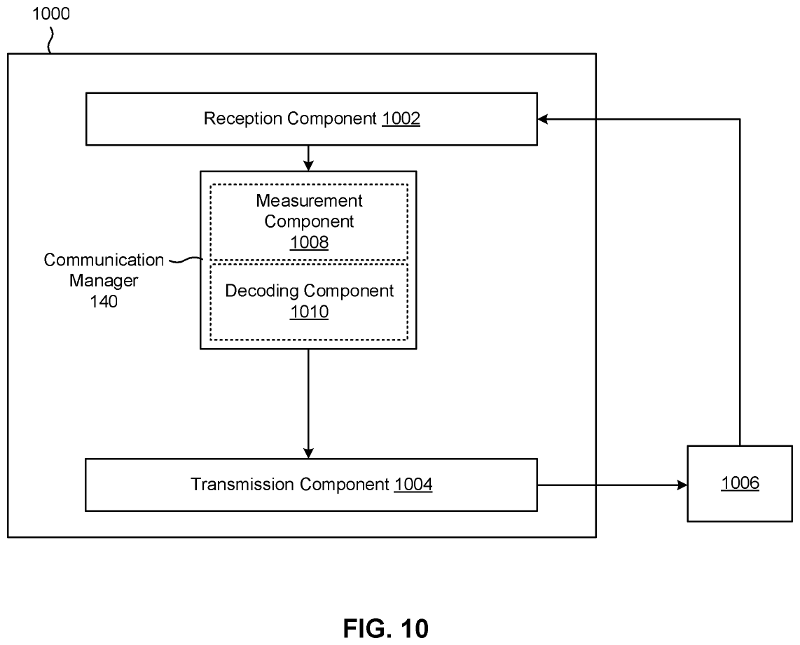

In some aspects, a UE (e.g., the UE 120 and/or apparatus 1000 of FIG. 10) may include means for receiving an indication of whether one or more first DMRS ports are delay-related validly QCL'd with one or more first reference signals based on frequency compensation performed by a network; and/or means for receiving data on a PDSCH based at least in part on the indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

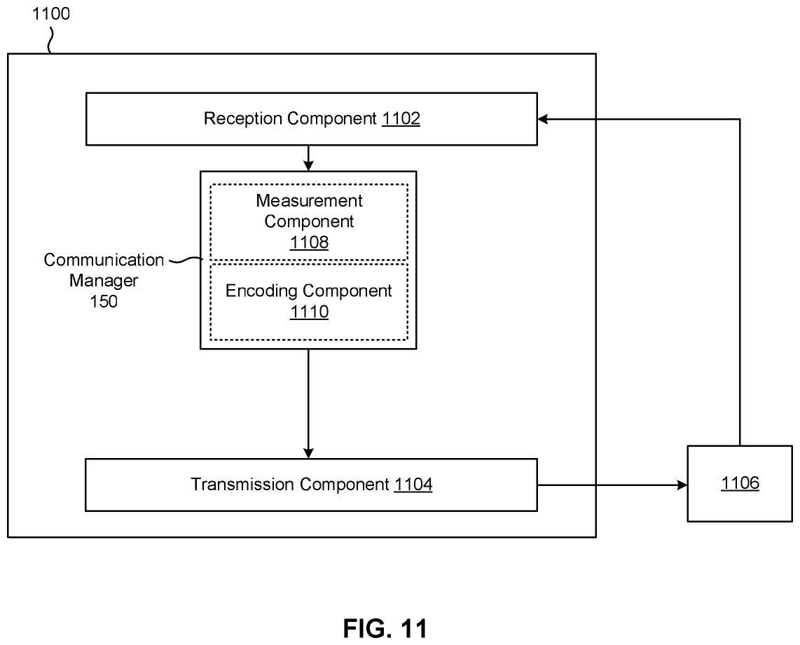

In some aspects, a network entity (e.g., the network node 110 and/or apparatus 1100 of FIG. 11) may include means for transmitting an indication of whether one or more first DMRS ports are delay-related validly QCL'd with one or more first reference signals based on frequency compensation performed by the network entity; and/or means for transmitting to a UE (e.g., the UE 120 and/or apparatus 1000 of FIG. 10) based on the indication. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

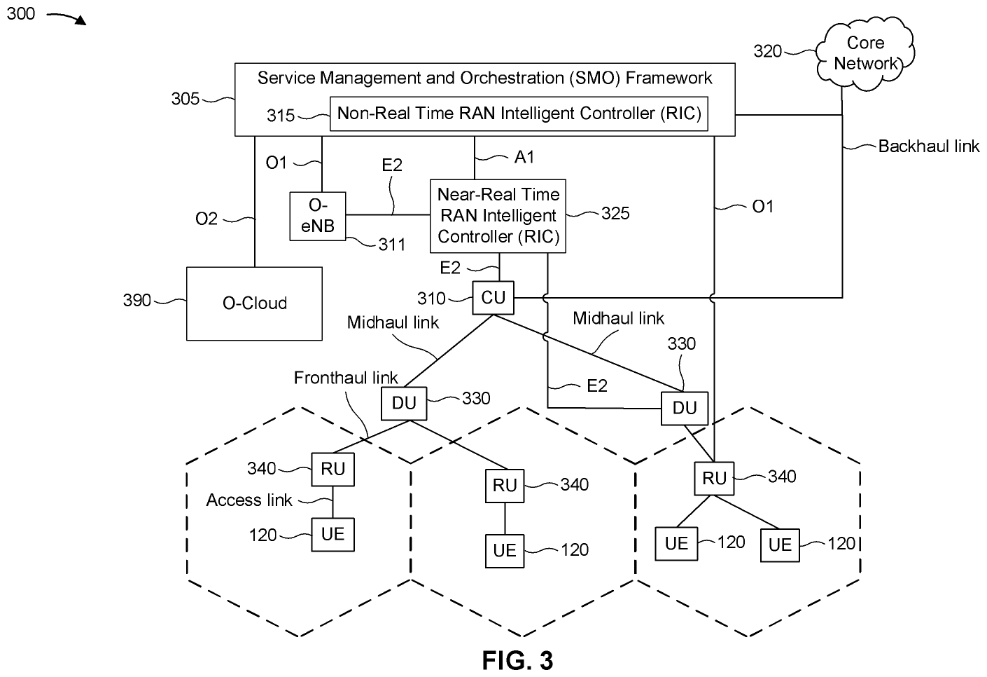

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

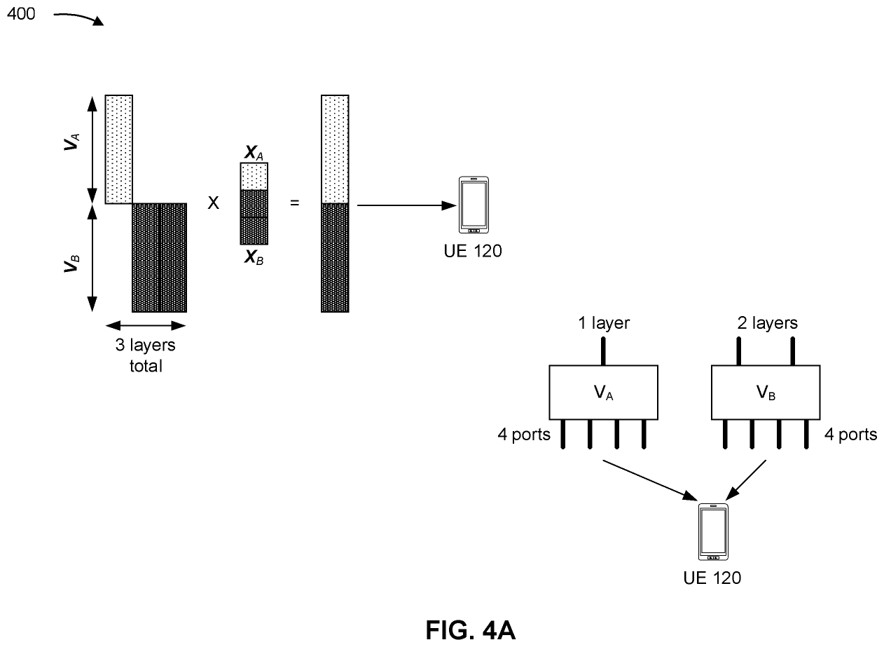

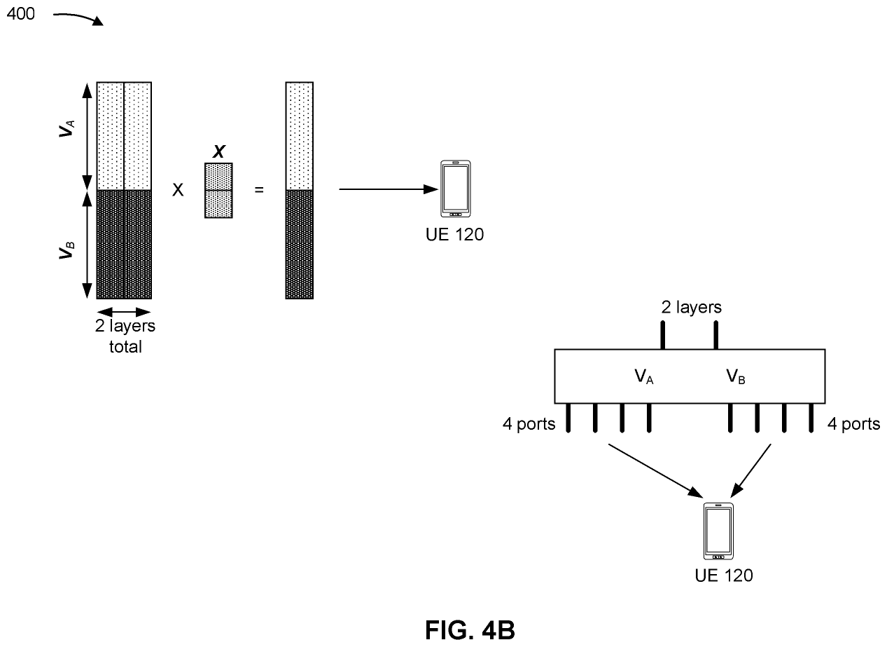

FIG. 4A is a diagram illustrating an example 400 of non-coherent joint transmission (NCJT), in accordance with the present disclosure. As shown in FIG. 4A, example 400 uses a first precoder associated with a first TRP of a network node 110 represented by V_{A}. The first precoder may have dimensions based on a quantity of ports associated with the first TRP (e.g., represented by

$${N}_{t}^{TRP 1}$$

and equal to 4 in example 400) and a rank indicator associated with the first TRP (e.g., represented by RI^{TRP1} and equal to 1 in example 400). Accordingly, the first TRP transmits using one layer in example 400. Other examples may use additional ports (e.g., 5, 6, and so on) or fewer ports (e.g., 3, 2, or 1). Additionally, or alternatively, other examples may use additional layers (e.g., 2, 3, and so on).

As further shown in FIG. 4A, example 400 uses a second precoder associated with a second TRP of a network node 110 represented by V_{B}. The second precoder may have dimensions based on a quantity of ports associated with the second TRP (e.g., represented by

$${N}_{t}^{TRP 2}$$

and equal to 4 in example 400) and a rank indicator associated with the second TRP (e.g., represented by RI^{TRP2} and equal to 2 in example 400). Accordingly, the second TRP transmits using two layers in example 400. Other examples may use additional ports (e.g., 5, 6, and so on) or fewer ports (e.g., 3, 2, or 1). Additionally, or alternatively, other examples may use additional layers (e.g., 3, 4, and so on) or fewer layers (e.g., 1 layer).

Accordingly, multiple TRPs are included in (or at least controlled by) the network node 110 and may share hardware circuitry, a hardware controller, and/or other hardware components. In some aspects, different TRPs may include different antennas (also referred to as panels). Accordingly, a TRP may be referred to as a panel, an antenna array, or an array, among other examples. Although example 400 uses two TRPs, other examples may include additional TRPs (e.g., three TRPs, four TRPs, and so on).

A “port” may be defined such that a channel, over which a symbol on the port is conveyed, can be inferred from a channel over which another symbol on the same port is conveyed. Channel coefficients may represent weighting factors (e.g., indicating phase and/or gain) applied to each channel. Such weighting factors may be applied to the channels to improve signal power and/or signal quality at one or more receivers. Applying such weighting factors to channel transmissions may be referred to as “precoding,” and “precoder” may refer to a specific set of weighting factors applied to a set of channels.

Accordingly, one layer of data (e.g., represented by X_{A}) is precoded using the first precoder, and two layers of data (e.g., represented by X_{B}) are precoded using the second precoder. As a result, the network node 110 may individually transmit (e.g., to a UE 120) the precoded data corresponding to the first TRP and the precoded data corresponding to the second TRP. Because the data is separately precoded and transmitted on different TRPs, example 400 represents an example of NCJT.

FIG. 4B is a diagram illustrating an example 450 of coherent joint transmission (CJT), in accordance with the present disclosure. As shown in FIG. 4B, example 450 uses a first precoder associated with a first TRP of a network node 110 represented by V_{A}. The first precoder may have dimensions based on a quantity of ports associated with the first TRP (e.g., represented by

$${N}_{t}^{TRP 1}$$

and equal to 4 in example 450) and a rank indicator (e.g., represented by

$${RI}_{max}^{TRP}$$

and equal to 2 in example 450). Accordingly, the first TRP transmits using two layers in example 400. Other examples may use additional ports (e.g., 5, 6, and so on) or fewer ports (e.g., 3, 2, or 1). Additionally, or alternatively, other examples may use additional layers (e.g., 3, 4, and so on) or fewer layers (e.g., 1 layer).

As further shown in FIG. 4B, example 450 uses a second precoder associated with a second TRP of a network node 110 represented by V_{B}. The second precoder may have dimensions based on a quantity of ports associated with the second TRP (e.g., represented by

$${N}_{t}^{TRP 2}$$

and equal to 4 in example 450) and the rank indicator (e.g., represented by

$${RI}_{max}^{TRP}$$

and equal to 2 in example 450). Accordingly, the second TRP transmits using two layers in example 450. Other examples may use additional ports (e.g., 5, 6, and so on) or fewer ports (e.g., 3, 2, or 1). Additionally, or alternatively, other examples may use additional layers (e.g., 3, 4, and so on) or fewer layers (e.g., 1 layer).

Accordingly, two layers of data (e.g., represented by X) is jointly precoded using the first precoder and the second precoder. As a result, the network node 110 may jointly transmit (e.g., to a UE 120) the precoded data using the first TRP and the second TRP. Because the data is jointly precoded and transmitted on multiple TRPs, example 450 represents an example of CJT.

Because different TRPs may have different distances from a UE, arrived signals from one TRP may have a different propagation delay as compared with arrived signals from another TRP. The propagation delay difference is proportional to a distance between TRPs (e.g., on the order of x/c, where x represents the distance and c represents the speed of light). For example, if two TRPs are 1000 meters apart, the proposition delay difference may be approximately 3.33 microseconds (μs). As a result, a coherent bandwidth between the two TRPs may be approximately 300 kilohertz (kHz).

However, subbands are often larger than 300 kHz. For example, a minimum subband is 360 kHz when a 15 kHz subcarrier spacing (SCS) is used. A “subband” is a subset of frequencies within a larger set of frequencies on a frequency “band.” Generally, a subband is smaller than a bandwidth part and includes a subset of a set of frequency resources used on a wideband channel. As used herein, “bandwidth part” or “BWP” may refer to a contiguous set of physical resource blocks (PRBs), where each PRB includes a set of frequencies corresponding to one or more subcarriers. “Subcarrier” may refer to a frequency based at least in part on a “carrier” frequency, and subcarriers may be aggregated to convey information wirelessly (e.g., using OFDM symbols and/or other RF symbols).

To improve quality and reliability of communications transmitted using multiple TRPs, a network entity (e.g., network node 110) may compensate for propagation delay by multiplying each subcarrier with frequency-domain compensation coefficients (e.g., of the form e^{j2πτf}^{ₖ}, where τ represents the propagation delay and fₖ represents a frequency of the subcarrier), such as linear phase shifts. The frequency compensation may change properties of signals from TRPs of the network node such that some ports (e.g., DMRS ports) are no longer QCL'd with reference signals, at least with respect to delay information such as average spread or delay spread. Accordingly, the QCL relationship between the ports and the reference signals will be referred to as no longer “delay-related valid.” Some techniques and apparatuses described herein enable the network node 110 to indicate to a UE (e.g., UE 120) when frequency compensation is applied. Accordingly, the UE 120 can determine whether one or more first DMRS ports are delay-related validly QCL'd with one or more first reference signals. As a result, the UE 120 experiences improved quality and reliability on a downlink channel (e.g., on a PDSCH) because the UE 120 does not use the delay information of a QCL type that is not delay-related valid for the downlink channel. Improving quality and reliability also conserves power and processing resources at the UE 120 and at the network node 110 by reducing chances of retransmissions.

As indicated above, FIGS. 4A and 4B are provided as examples. Other examples may differ from what is described with regard to FIGS. 4A and 4B.

FIG. 5 is a diagram illustrating an example 500 associated with QCL'd transmission configuration indication (TCI) states for communications between a network node 110 and a UE 120, in accordance with the present disclosure. As shown in FIG. 5, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The network node 110 may transmit downlink communications via one or more BS transmit beams 505.

The UE 120 may attempt to receive downlink transmissions via one or more UE receive beams 510, which may be configured using different beamforming parameters at receive circuitry of the UE 120. The UE 120 may identify a particular BS transmit beam 505, shown as BS transmit beam 505-A, and a particular UE receive beam 510, shown as UE receive beam 510-A, that provide relatively favorable performance (for example, that have a best channel quality of the different measured combinations of BS transmit beams 505 and UE receive beams 510). In some examples, the UE 120 may transmit an indication of which BS transmit beam 505 is identified by the UE 120 as a preferred BS transmit beam, which the network node 110 may select for transmissions to the UE 120. The UE 120 may thus attain and maintain a beam pair link (BPL) with the network node 110 for downlink communications (for example, a combination of the BS transmit beam 505-A and the UE receive beam 510-A), which may be further refined and maintained in accordance with one or more established beam refinement procedures.

A downlink beam, such as a BS transmit beam 505 or a UE receive beam 510, may be associated with a TCI state. A TCI state may indicate a directionality or a characteristic of the downlink beam, such as one or more QCL properties of the downlink beam. As used herein, “quasi-co-location” refers to a situation in which properties of a channel over which a symbol on one port is conveyed can be inferred from a channel over which a symbol on the other antenna port is conveyed.

A QCL property may include, for example, a Doppler shift, a Doppler spread, an average delay, a delay spread, or spatial receive parameters, among other examples. In some examples, each BS transmit beam 505 may be associated with a synchronization signal block (SSB), and the UE 120 may indicate a preferred BS transmit beam 505 by sending a report message. A particular SSB may have an associated TCI state (for example, for an antenna port or for beamforming). The network node 110 may, in some examples, indicate a downlink BS transmit beam 505 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 510 at the UE 120. Thus, the UE 120 may select a corresponding UE receive beam 510 from a set of BPLs based at least in part on the network node 110 indicating a BS transmit beam 505 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional BS receive beam. Each UE transmit beam may have an associated beam ID, beam direction, or beam symbols, among other examples. The UE 120 may transmit uplink communications via one or more UE transmit beams 515.

The network node 110 may receive uplink transmissions via one or more BS receive beams 520. The network node 110 may identify a particular UE transmit beam 515, shown as UE transmit beam 515-A, and a particular BS receive beam 520, shown as BS receive beam 520-A, that provide relatively favorable performance (for example, that have a best channel quality of the different measured combinations of UE transmit beams 515 and BS receive beams 520). In some examples, the network node 110 may transmit an indication of which UE transmit beam 515 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 515-A and the BS receive beam 520-A), which may be further refined and maintained in accordance with one or more established beam refinement procedures. An uplink beam, such as a UE transmit beam 515 or a BS receive beam 520, may be associated with a spatial relation. A spatial relation may indicate a directionality or a characteristic of the uplink beam, similar to one or more QCL properties, as described above.

When transmitting using multiple TRPs, the network node 110 may apply different TCI states to different TRPs. For example, the network node 110 may apply a first TCI state for a first reference signal (e.g., a CSI-RS, a tracking reference signal (TRS), and/or another type of reference signal) transmitted by a first TRP and apply a second TCI state for a second reference signal transmitted by a second TRP. Additionally, the network node 110 may assign different TCI states to different DMRS ports (or different code division multiplexing (CDM) groups of DMRS ports) when transmitted on a PDSCH. For example, the network node 110 may apply a first TCI state associated with the first TRP for the PDSCH and apply a second TCI state associated with the second TRP for the PDSCH.

Accordingly, the UE 120 may receive the DMRS ports based on delay information (e.g., average delay and/or delay spread) in a QCL type associated with reference signals (also referred to as “sources”) indicated in the TCI states. QCL types may include QCL typeA (e.g., indicating a source for Doppler shift, Doppler spread, average delay, and delay spread), a QCL typeB (e.g., indicating a source for Doppler shift and Doppler spread), a QCL typeC (e.g., indicating a source for Doppler shift and average delay), and a QCL typeD (e.g., indicating a source for a spatial reception (Rx) parameter). However, the delay information may be invalid when the network node 110 applies frequency compensation (e.g., when the network node 110 uses frequency compensation for reference signals (e.g., SSB or CSI-RS) but not for the PDSCH or when the network node 110 uses frequency compensation for some reference signals and not others).

Accordingly, the network node 110 may transmit an indication of whether one or more first DMRS ports are delay-related validly QCL'd with one or more first reference signals based on frequency compensation performed by the network node. Accordingly, the UE 120 may receive on the PDSCH based at least in part on the indication. For example, the UE 120 may receive the one or more first DMRS ports based on the delay information when the one or more first DMRS ports are delay-related validly QCL'd with the one or more first reference signals and may refrain from receiving the one or more first DMRS ports based on the delay information when the one or more first DMRS ports are not delay-related validly QCL'd with the one or more first reference signals. As a result, the UE 120 experiences improved quality and reliability on the PDSCH because the UE 120 does not use the delay information of a QCL type that is not delay-related valid for the PDSCH. Improving quality and reliability also conserves power and processing resources at the UE 120 and at the network node 110 by reducing chances of retransmissions.

The indication may be included in a PDSCH configuration (e.g., in a PDSCH-Config data structure, as defined in 3GPP specifications and/or another standard) and may therefore indicate QCL validity between the one or more first DMRS ports and all TRPs associated with the network node 110. Additionally, or alternatively, the indication may be included in TCI states associated with the PDSCH (e.g., in an FD-compensated parameter included in one or more TOI-State data structures, as defined in 3GPP specifications and/or another standard) and may therefore indicate QCL validity between the one or more first DMRS ports and individual TRPs of the network node 110 (e.g., QCL validity is determined on a per-TRP basis according to which TCI states are activated for which TRPs).

As indicated above, FIG. 5 is provided as an example. Other examples may differ from what is described with respect to FIG. 5.

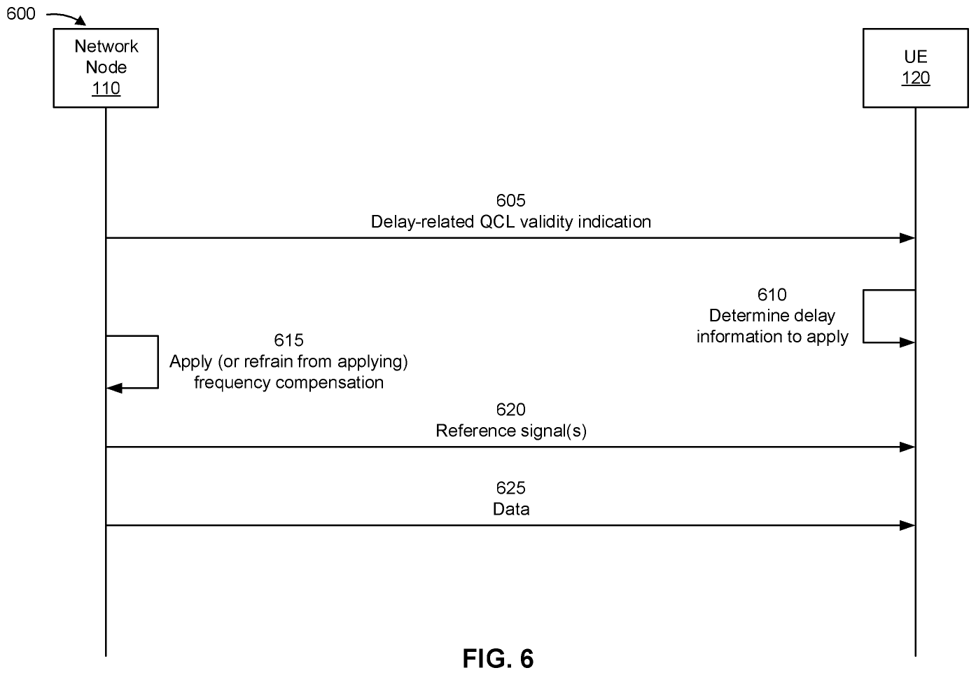

FIG. 6 is a diagram illustrating an example 600 associated with QCL between DMRS ports and reference signals during frequency compensation, in accordance with the present disclosure. As shown in FIG. 6, a network node 110 and a UE 120 may communicate with one another over-the-air (OTA) (e.g., on a wireless network, such as wireless network 100).

As shown by reference number 605, the network node 110 may transmit, and the UE 120 may receive, an indication of whether one or more first DMRS ports are delay-related validly QCL'd with one or more first reference signals based on frequency compensation performed by the network node 110. For example, the indication may be included in a PDSCH configuration and thus apply to all TRPs used for the PDSCH (e.g., as described in connection with FIG. 5). Additionally, or alternatively, the indication may be included in a TCI state and thus apply to any TRPs using the TCI state (e.g., as described in connection with FIG. 5).

In some aspects, the network node 110 may transmit, and the UE 120 may receive, a configuration associated with a sounding reference signal (SRS). Accordingly, the UE 120 may transmit the SRS based on the configuration (e.g., according to the time, frequency, and/or spatial resources indicated in the configuration), and the network node 110 may measure the SRS. For example, the network node 110 may measure the SRS at a plurality of TRPs in order to determine propagation delays between the TRPs. Accordingly, the network node 110 may determine whether to perform frequency compensation for the first reference signal(s), the PDSCH (including DMRS for the PDSCH), and/or a combination thereof. For example, the network node 110 may determine to perform frequency compensation for the PDSCH when the estimated propagation delay between two TRPs used for the PDSCH satisfies a delay threshold. Additionally, or alternatively, the network node 110 may determine not to perform frequency compensation for the first reference signal(s) when other UEs are using the first reference signal(s). For example, when another UE is a distance from the UE 120 that satisfies a distance threshold, the network node 110 may determine not to perform frequency compensation for the first reference signal(s).

Additionally, or alternatively, the network node 110 may transmit the first reference signal(s) without frequency compensation, and the UE 120 may measure the first reference signal(s). Accordingly, the UE 120 may transmit, and the network node 110 may receive, a report (e.g., a channel state information (CSI) report) based on one or more measurements of the first reference signal(s) (e.g., including an RSRP value, an RSRQ value, an RSSI value, a channel quality indictor (CQI), a precoding matrix indicator (PMI), a layer indicator (LI), a rank indicator (RI), a Doppler frequency indicator, and/or another direct or derived value from the measurements). Accordingly, the network node 110 may perform frequency compensation for the PDSCH based on the report. For example, the network node 110 may determine to perform frequency compensation for the PDSCH when an estimated propagation delay between two TRPs used for the PDSCH satisfies a delay threshold. The frequency compensation may be implemented based on delay values indicated in the report or derived from information in the report.

As shown by reference number 610, the UE 120 may determine delay information to apply for receiving data (e.g., on the PDSCH). For example, as described in connection with FIG. 5, the UE 120 may receive the first DMRS port(s) based on the delay information in a QCL type associated with the first reference signal(s) when one or more first DMRS ports are delay-related validly QCL'd with the reference signal(s). On the other hand, the UE 120 may refrain from receiving the first DMRS port(s) based on the delay information in a QCL type associated with the first reference signal(s) when the one or more first DMRS ports are not delay-related validly QCL'd with the first reference signal(s).

In some aspects, the network node 110 may apply a single delay compensation value such that a delay spread in a TCI state is still valid even when the one or more first DMRS ports are not delay-related validly QCL'd with the reference signal of the TCI state. Accordingly, the UE 120 may refrain from using average delay information in the TCI state but may still use the delay spread information. Alternatively, the network node 110 may apply a plurality of delay compensation values such that both delay spread and average delay in a TCI state are invalid when the one or more first DMRS ports are not delay-related validly QCL'd with the reference signal of the TCI state.

As shown by refence number 615, the network node 110 may apply (or not apply) frequency compensation. In some aspects, the frequency compensation may be applied relative to a first TRP, of a plurality of TRPs used by the network node 110. Accordingly, the indication of delay-related QCL validity is associated with one or more of the plurality of TRPs but excludes the first TRP. In other words, the one or more first DMRS ports are delay-related validly QCL'd with reference signals from the first TRP, regardless of the indication, because the first TRP is not frequency compensated. Alternatively, the frequency compensation may be applied to the plurality of TRPs used by the network node 110. Accordingly, the indication of delay-related QCL validity is associated with one or more of the plurality of TRPs (e.g., whichever TRPs are used for the PDSCH).

As shown by reference number 620, the network node 110 may transmit the first reference signal(s). For example, the network node 110 may transmit the first reference signal(s) with the frequency compensation (or without frequency compensation), as described herein.

As shown by reference number 625, the network node 110 may transmit, and the UE 120 may receive, data on a PDSCH. The network node 110 may transmit on the PDSCH with the frequency compensation (or without frequency compensation), as described herein. The UE 120 may receive data on the PDSCH (e.g., using the first DMRS port(s)) based at least in part on the indication of delay-related QCL validity. For example, as described above, the UE 120 may receive the first DMRS port(s) based on the delay information in a QCL type associated with the first reference signal(s) when one or more first DMRS ports are delay-related validly QCL'd with the reference signal(s). On the other hand, the UE 120 may refrain from receiving the first DMRS port(s) based on the delay information in a QCL type associated with the first reference signal(s) when the one or more first DMRS ports are not delay-related validly QCL'd with the first reference signal(s).

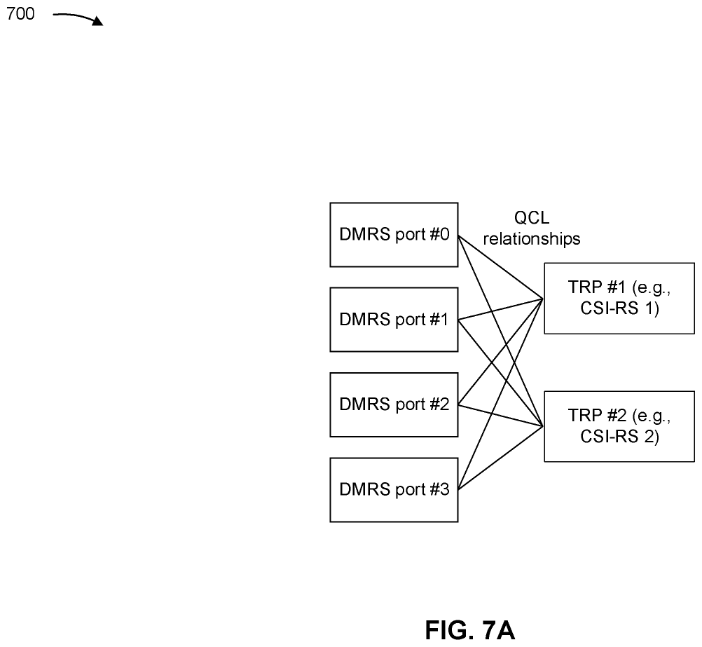

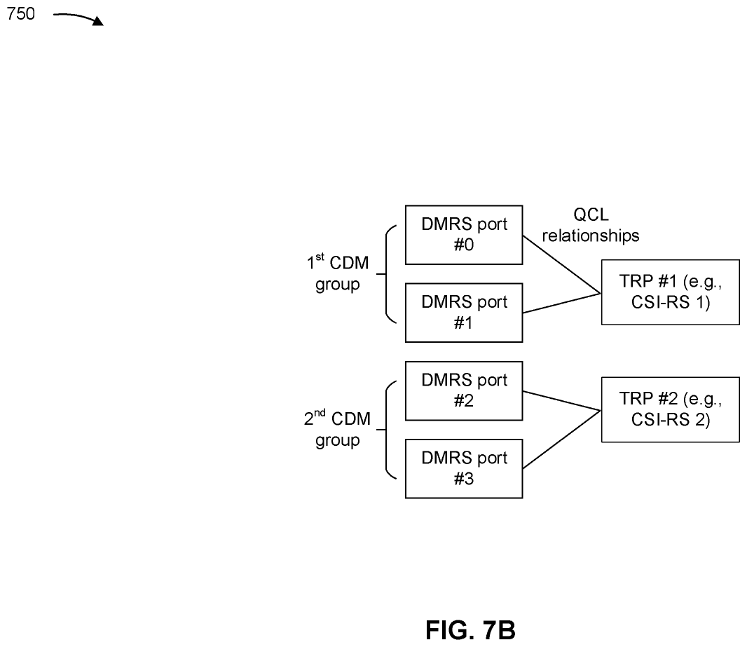

In some aspects, the data is received using CJT. Accordingly, the one or more first DMRS ports may include all DMRS ports associated with the UE 120, as shown in FIG. 7A. Alternatively, the data is received using NCJT. Accordingly, the one or more first DMRS ports may be included in at least one CDM group, as shown in FIG. 7B. In some aspects, the frequency compensation may be applied relative to a first TRP, of a plurality of TRPs used by the network node 110. Accordingly, the indication of delay-related QCL validity is associated with a second CDM group (associated with a second TRP) but excludes the first CDM group (associated with the first TRP). In other words, DMRS ports of the first CDM group are delay-related validly QCL'd with reference signals from the first TRP, regardless of the indication, because the first TRP is not frequency compensated. Alternatively, the frequency compensation may be applied to the plurality of TRPs used by the network node 110. Accordingly, the indication of delay-related QCL validity is associated with the second CDM group as well as the first CDM group (e.g., whichever CDM groups are associated with TRPs used for the PDSCH).

By using techniques as described in connection with FIG. 6, the network node 110 indicates whether the one or more first DMRS ports are delay-related validly QCL'd with the first reference signal(s). As a result, the UE 120 experiences improved quality and reliability on the PDSCH because the UE 120 does not use the delay information of a QCL type that is not delay-related valid for the PDSCH. Improving quality and reliability also conserves power and processing resources at the UE 120 and at the network node 110 by reducing chances of retransmissions.

As indicated above, FIG. 6 is provided as an example. Other examples may differ from what is described with respect to FIG. 6.

FIG. 7A is a diagram illustrating an example 700 associated with QCL between DMRS ports and reference signals during frequency compensation in CJT, in accordance with the present disclosure. As shown in FIG. 7A, for CJT, each DMRS port is associated with all TRPs. Accordingly, the delay-related validity for the QCL relationship between DMRS ports and source reference signals applies to all DMRS ports associated with a UE, as described in connection with FIG. 6.

FIG. 7B is a diagram illustrating an example 750 associated with QCL between DMRS ports and reference signals during frequency compensation in NCJT, in accordance with the present disclosure. As shown in FIG. 7B, for NCJT, different CDM groups of DMRS ports are associated with different TRPs. Accordingly, the delay-related validly for the QCL relationship between DMRS ports and source reference signals applies on a per-CDM group basis, as described in connection with FIG. 6.

As indicated above, FIGS. 7A and 7B are provided as examples. Other examples may differ from what is described with respect to FIGS. 7A and 7B.

FIG. 8 is a diagram illustrating an example process 800 performed, for example, by a UE, in accordance with the present disclosure. Example process 800 is an example where the UE (e.g., UE 120 and/or apparatus 1000 of FIG. 10) performs operations associated with QCL between DMRS ports and reference signals during frequency compensation.

As shown in FIG. 8, in some aspects, process 800 may include receiving an indication of whether one or more first DMRS ports are delay-related validly QCL'd with one or more first reference signals based on frequency compensation performed by a network (e.g., including network node 110 and/or apparatus 1100 of FIG. 11) (block 810). For example, the UE (e.g., using communication manager 140 and/or reception component 1002, depicted in FIG. 10) may receive an indication of whether one or more first DMRS ports are delay-related validly QCL'd with one or more first reference signals based on frequency compensation performed by a network, as described herein.

As further shown in FIG. 8, in some aspects, process 800 may include receiving (e.g., from the network) data on a PDSCH based at least in part on the indication (block 820). For example, the UE (e.g., using communication manager 140 and/or reception component 1002) may receive data on a PDSCH based at least in part on the indication, as described herein.

Process 800 may include additional aspects, such as any single aspect or any combination of aspects described below and/or in connection with one or more other processes described elsewhere herein.

In a first aspect, process 800 includes receiving (e.g., using communication manager 140 and/or reception component 1002) the one or more first DMRS ports based on delay information in a QCL type associated with the one or more first reference signals when the one or more first DMRS ports are delay-related validly QCL'd with the one or more first reference signals.

In a second aspect, alone or in combination with the first aspect, process 800 includes refraining from receiving (e.g., using communication manager 140 and/or reception component 1002) the one or more first DMRS ports based on delay information in a QCL type associated with the one or more first reference signals when the one or more first DMRS ports are not delay-related validly QCL'd with the one or more first reference signals.

In a third aspect, alone or in combination with one or more of the first and second aspects, the delay information includes average delay or a combination of average delay and delay spread.

In a fourth aspect, alone or in combination with one or more of the first through third aspects, the indication is included in a configuration associated with the PDSCH.

In a fifth aspect, alone or in combination with one or more of the first through fourth aspects, the indication is associated with all TRPs associated with the PDSCH.

In a sixth aspect, alone or in combination with one or more of the first through fifth aspects, the indication is included in a TCI state associated with the PDSCH.

In a seventh aspect, alone or in combination with one or more of the first through sixth aspects, the indication is associated with a TRP associated with the TCI state.

In an eighth aspect, alone or in combination with one or more of the first through seventh aspects, the frequency compensation is relative to a first TRP of a plurality of TRPs used by the network, and the indication is associated with one or more of the plurality of TRPs excluding the first TRP.

In a ninth aspect, alone or in combination with one or more of the first through eighth aspects, the frequency compensation is applied to a plurality of TRPs used by the network, and the indication is associated with one or more of the plurality of TRPs.

In a tenth aspect, alone or in combination with one or more of the first through ninth aspects, the data is received using CJT, and the one or more first DMRS ports include all DMRS ports associated with the UE.

In an eleventh aspect, alone or in combination with one or more of the first through tenth aspects, the data is received using NCJT, and the one or more first DMRS ports are included in at least one CDM group.

In a twelfth aspect, alone or in combination with one or more of the first through eleventh aspects, the at least one CDM group includes a second CDM group and excludes a first CDM group.

In a thirteenth aspect, alone or in combination with one or more of the first through twelfth aspects, the at least one CDM group includes a first CDM group and a second CDM group.

In a fourteenth aspect, alone or in combination with one or more of the first through thirteenth aspects, process 800 includes receiving (e.g., using communication manager 140 and/or reception component 1002) a configuration associated with an SRS, and transmitting (e.g., using communication manager 140 and/or transmission component 1004, depicted in FIG. 10) the SRS based on the configuration, such that the indication is based at least in part on the SRS.

In a fifteenth aspect, alone or in combination with one or more of the first through fourteenth aspects, process 800 includes measuring (e.g., using communication manager 140 and/or measurement component 1008, depicted in FIG. 10) the one or more first reference signals, and transmitting (e.g., using communication manager 140 and/or transmission component 1004) a report based on the measuring, such that the indication is based at least in part on the report.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network node 110 and/or apparatus 1100 of FIG. 11) performs operations associated with QCL between DMRS ports and reference signals during frequency compensation.

As shown in FIG. 9, in some aspects, process 900 may include transmitting an indication of whether one or more first DMRS ports are delay-related validly QCL'd with one or more first reference signals based on frequency compensation performed by the network entity (block 910). For example, the network entity (e.g., using communication manager 150 and/or transmission component 1104, depicted in FIG. 11) may transmit an indication of whether one or more first DMRS ports are delay-related validly QCL'd with one or more first reference signals based on frequency compensation performed by the network entity, as described herein.

As further shown in FIG. 9, in some aspects, process 900 may include transmitting to a UE (e.g., UE 120 and/or apparatus 1000 of FIG. 10) based on the indication (block 920). For example, the network entity (e.g., using communication manager 150 and/or transmission component 1104) may transmit to a UE based on the indication, as described herein.

Process 900 may include additional aspects, such as any single aspect or any combination of aspects described below and/or in connection with one or more other processes described elsewhere herein.

In a first aspect, transmitting to the UE includes transmitting the one or more first reference signals with the frequency compensation, and transmitting the one or more first DMRS ports with the frequency compensation.

In a second aspect, alone or in combination with the first aspect, transmitting to the UE includes transmitting the one or more first reference signals without the frequency compensation, and transmitting the one or more first DMRS ports with the frequency compensation.

In a third aspect, alone or in combination with one or more of the first and second aspects, the indication is included in a configuration associated with a PDSCH.

In a fourth aspect, alone or in combination with one or more of the first through third aspects, the indication is associated with all TRPs associated with the PDSCH.

In a fifth aspect, alone or in combination with one or more of the first through fourth aspects, the indication is included in a TCI state.

In a sixth aspect, alone or in combination with one or more of the first through fifth aspects, the indication is associated with a TRP associated with the TCI state.

In a seventh aspect, alone or in combination with one or more of the first through sixth aspects, the frequency compensation is relative to a first TRP of a plurality of TRPs associated with the network entity, and the indication is associated with one or more of the plurality of TRPs excluding the first TRP.

In an eighth aspect, alone or in combination with one or more of the first through seventh aspects, the frequency compensation is applied to a plurality of TRPs associated with the network entity, and the indication is associated with one or more of the plurality of TRPs.

In a ninth aspect, alone or in combination with one or more of the first through eighth aspects, transmitting to the UE includes transmitting using CJT, and the one or more first DMRS ports include all DMRS ports associated with the UE.

In a tenth aspect, alone or in combination with one or more of the first through ninth aspects, transmitting to the UE includes transmitting using NCJT, and the one or more first DMRS ports are included in at least one CDM group.

In an eleventh aspect, alone or in combination with one or more of the first through tenth aspects, the at least one CDM group includes a second CDM group and excludes a first CDM group.

In a twelfth aspect, alone or in combination with one or more of the first through eleventh aspects, the at least one CDM group includes a first CDM group and a second CDM group.

In a thirteenth aspect, alone or in combination with one or more of the first through twelfth aspects, process 900 includes transmitting (e.g., using communication manager 150 and/or transmission component 1104) a configuration associated with an SRS, and measuring (e.g., using communication manager 150 and/or measurement component 1108) the SRS based on the configuration, such that the indication is based at least in part on measuring the SRS.

In a fourteenth aspect, alone or in combination with one or more of the first through thirteenth aspects, process 900 includes transmitting (e.g., using communication manager 150 and/or transmission component 1104) the one or more first reference signals, and receiving (e.g., using communication manager 150 and/or reception component 1102, depicted in FIG. 11) a report associated with the one or more first reference signals, such that the indication is based at least in part on the report.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008 and/or a decoding component 1010, among other examples.

In some aspects, the apparatus 1000 may be configured to perform one or more operations described herein in connection with FIGS. 5, 6, 7A, and 7B. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

In some aspects, the reception component 1002 may receive (e.g., from the apparatus 1006, such as a network entity) an indication of whether one or more first DMRS ports are delay-related validly QCL'd with one or more first reference signals based on frequency compensation performed by a network. Accordingly, the reception component 1002 may receive data on a PDSCH based at least in part on the indication. For example, the decoding component 1010 may determine whether to decode wireless signals from the apparatus 1006 using a QCL type associated with the one or more first reference signal. The decoding component 1010 may include a modem, a demodulator, a MIMO detector, a receive processor, or a combination thereof, of the UE described in connection with FIG. 2.

In some aspects, the reception component 1002 may receive the one or more first DMRS ports based on delay information in a QCL type associated with the one or more first reference signals when the one or more first DMRS ports are delay-related validly QCL'd with the one or more first reference signals. Alternatively, the reception component 1002 may refrain from receiving the one or more first DMRS ports based on delay information in a QCL type associated with the one or more first reference signals when the one or more first DMRS ports are not delay-related validly QCL'd with the one or more first reference signals.

In some aspects, the reception component 1002 may receive (e.g., from the apparatus 1006) a configuration associated with an SRS. Accordingly, the transmission component 1004 may transmit (e.g., to the apparatus 1006) the SRS based on the configuration such that the indication is based at least in part on the SRS.

Additionally, or alternatively, the measurement component 1008 may measure the one or more first reference signals. The measurement component 1008 may include one or more antennas, a modem, a demodulator, a MIMO detector, a receive processor, or a combination thereof, of the UE described in connection with FIG. 2. Accordingly, the transmission component 1004 may transmit (e.g., to the apparatus 1006) a report based on the measuring such that the indication is based at least in part on the report.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include one or more of a measurement component 1108 and/or an encoding component 1110, among other examples.

In some aspects, the apparatus 1100 may be configured to perform one or more operations described herein in connection with FIGS. 5, 6, 7A, and 7B. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

In some aspects, the transmission component 1104 may transmit (e.g., to the apparatus 1106, such as a UE) an indication of whether one or more first DMRS ports are delay-related validly QCL'd with one or more first reference signals based on frequency compensation performed by the apparatus 1100. Accordingly, the transmission component 1104 may transmit to the apparatus 1106 based on the indication. For example, the encoding component 1110 may encode wireless signals from the apparatus 1100 with or without frequency compensation. The encoding component 1110 may include a modem, a modulator, a transmit MIMO processor, a transmit processor, or a combination thereof, of the network node described in connection with FIG. 2.

In some aspects, the transmission component 1104 may transmit (e.g., to the apparatus 1106) a configuration associated with an SRS. Accordingly, the measurement component 1108 may measure the SRS based on the configuration, such that the indication is based at least in part on measuring the SRS. The measurement component 1108 may include one or more antennas, a modem, a demodulator, a MIMO detector, a receive processor, a controller/processor, a memory, or a combination thereof, of the network node described in connection with FIG. 2.

Additionally, or alternatively, the transmission component 1104 may transmit the one or more first reference signals. Accordingly, the reception component 1102 may receive (e.g., from the apparatus 1106) a report associated with the one or more first reference signals such that the indication is based at least in part on the report.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication of whether one or more first demodulation reference signal (DMRS) ports are delay-related validly quasi-co-located (QCL'd) with one or more first reference signals based on frequency compensation performed by a network; and receiving data on a physical downlink shared channel (PDSCH) based at least in part on the indication.

Aspect 2: The method of Aspect 1, further comprising: receiving the one or more first DMRS ports based on delay information in a QCL type associated with the one or more first reference signals when the one or more first DMRS ports are delay-related validly QCL'd with the one or more first reference signals.

Aspect 3: The method of Aspect 1, further comprising: refraining from receiving the one or more first DMRS ports based on delay information in a QCL type associated with the one or more first reference signals when the one or more first DMRS ports are not delay-related validly QCL'd with the one or more first reference signals.

Aspect 4: The method of any of Aspects 2 through 3, wherein the delay information includes average delay or a combination of average delay and delay spread.

Aspect 5: The method of any of Aspects 1 through 4, wherein the indication is included in a configuration associated with the PDSCH.

Aspect 6: The method of Aspect 5, wherein the indication is associated with all transmit-receive points associated with the PDSCH.

Aspect 7: The method of any of Aspects 1 through 4, wherein the indication is included in a transmission configuration indicator (TCI) state associated with the PDSCH.

Aspect 8: The method of Aspect 7, wherein the indication is associated with a transmit-receive point associated with the TCI state.

Aspect 9: The method of any of Aspects 1 through 8, wherein the frequency compensation is relative to a first transmit-receive point (TRP) of a plurality of TRPs used by the network, and the indication is associated with one or more of the plurality of TRPs excluding the first TRP.

Aspect 10: The method of any of Aspects 1 through 8, wherein the frequency compensation is applied to a plurality of transmit-receive points (TRPs) used by the network, and the indication is associated with one or more of the plurality of TRPs.

Aspect 11: The method of any of Aspects 1 through 10, wherein the data is received using coherent joint transmission, and the one or more first DMRS ports include all DMRS ports associated with the UE.

Aspect 12: The method of any of Aspects 1 through 10, wherein the data is received using non-coherent joint transmission, and the one or more first DMRS ports are included in at least one code division multiplexing (CDM) group.

Aspect 13: The method of Aspect 12, wherein the at least one CDM group includes a second CDM group and excludes a first CDM group.

Aspect 14: The method of Aspect 12, wherein the at least one CDM group includes a first CDM group and a second CDM group.

Aspect 15: The method of any of Aspects 1 through 14, further comprising: receiving a configuration associated with a sounding reference signal (SRS); and transmitting the SRS based on the configuration, wherein the indication is based at least in part on the SRS.

Aspect 16: The method of any of Aspects 1 through 15, further comprising: measuring the one or more first reference signals; and transmitting a report based on the measuring, wherein the indication is based at least in part on the report.

Aspect 17: A method of wireless communication performed by a network entity, comprising: transmitting an indication of whether one or more first demodulation reference signal (DMRS) ports are delay-related validly quasi-co-located (QCL'd) with one or more first reference signals based on frequency compensation performed by the network entity; and transmitting to a user equipment (UE) based on the indication.

Aspect 18: The method of Aspect 17, wherein transmitting to the UE comprises: transmitting the one or more first reference signals with the frequency compensation; and transmitting the one or more first DMRS ports with the frequency compensation.

Aspect 19: The method of Aspect 17, wherein transmitting to the UE comprises: transmitting the one or more first reference signals without the frequency compensation; and transmitting the one or more first DMRS ports with the frequency compensation.

Aspect 20: The method of any of Aspects 17 through 19, wherein the indication is included in a configuration associated with a physical downlink shared channel (PDSCH).

Aspect 21: The method of Aspect 20, wherein the indication is associated with all transmit-receive points associated with the PDSCH.

Aspect 22: The method of any of Aspects 17 through 19, wherein the indication is included in a transmission configuration indicator (TCI) state.

Aspect 23: The method of Aspect 22, wherein the indication is associated with a transmit-receive point associated with the TCI state.

Aspect 24: The method of any of Aspects 17 through 23, wherein the frequency compensation is relative to a first transmit-receive point (TRP) of a plurality of TRPs associated with the network entity, and the indication is associated with one or more of the plurality of TRPs excluding the first TRP.

Aspect 25: The method of any of Aspects 17 through 23, wherein the frequency compensation is applied to a plurality of transmit-receive points (TRPs) associated with the network entity, and the indication is associated with one or more of the plurality of TRPs.

Aspect 26: The method of any of Aspects 17 through 25, wherein transmitting to the UE comprises: transmitting using coherent joint transmission, wherein the one or more first DMRS ports include all DMRS ports associated with the UE.

Aspect 27: The method of any of Aspects 17 through 25, wherein transmitting to the UE comprises: transmitting using non-coherent joint transmission, wherein the one or more first DMRS ports are included in at least one code division multiplexing (CDM) group.

Aspect 28: The method of Aspect 27, wherein the at least one CDM group includes a second CDM group and excludes a first CDM group.

Aspect 29: The method of Aspect 27, wherein the at least one CDM group includes a first CDM group and a second CDM group.

Aspect 30: The method of any of Aspects 17 through 29, further comprising: transmitting a configuration associated with a sounding reference signal (SRS); and measuring the SRS based on the configuration, wherein the indication is based at least in part on measuring the SRS.

Aspect 31: The method of any of Aspects 17 through 30, further comprising: transmitting the one or more first reference signals; and receiving a report associated with the one or more first reference signals, wherein the indication is based at least in part on the report.

Aspect 32: An apparatus for wireless communication at a device, comprising a processor; memory coupled with the processor; and instructions stored in the memory and executable by the processor to cause the apparatus to perform the method of one or more of Aspects 1-16.

Aspect 33: A device for wireless communication, comprising a memory and one or more processors coupled to the memory, the one or more processors configured to perform the method of one or more of Aspects 1-16.

Aspect 34: An apparatus for wireless communication, comprising at least one means for performing the method of one or more of Aspects 1-16.

Aspect 35: A non-transitory computer-readable medium storing code for wireless communication, the code comprising instructions executable by a processor to perform the method of one or more of Aspects 1-16.

Aspect 36: A non-transitory computer-readable medium storing a set of instructions for wireless communication, the set of instructions comprising one or more instructions that, when executed by one or more processors of a device, cause the device to perform the method of one or more of Aspects 1-16.

Aspect 37: An apparatus for wireless communication at a device, comprising a processor; memory coupled with the processor; and instructions stored in the memory and executable by the processor to cause the apparatus to perform the method of one or more of Aspects 17-31.

Aspect 38: A device for wireless communication, comprising a memory and one or more processors coupled to the memory, the one or more processors configured to perform the method of one or more of Aspects 17-31.

Aspect 39: An apparatus for wireless communication, comprising at least one means for performing the method of one or more of Aspects 17-31.

Aspect 40: A non-transitory computer-readable medium storing code for wireless communication, the code comprising instructions executable by a processor to perform the method of one or more of Aspects 17-31.

Aspect 41: A non-transitory computer-readable medium storing a set of instructions for wireless communication, the set of instructions comprising one or more instructions that, when executed by one or more processors of a device, cause the device to perform the method of one or more of Aspects 17-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an indication of whether one or more first demodulation reference signal (DMRS) ports are delay-related validly quasi-co-located (QCL'd) with one or more first reference signals based on frequency compensation performed by a network; and
receive data on a physical downlink shared channel (PDSCH) based at least in part on the indication.

2. The apparatus of claim 1, wherein the one or more processors are further configured to:
receive the one or more first DMRS ports based on delay information in a QCL type associated with the one or more first reference signals when the one or more first DMRS ports are delay-related validly QCL'd with the one or more first reference signals.

3. The apparatus of claim 2, wherein the delay information includes average delay or a combination of average delay and delay spread.

4. The apparatus of claim 1, wherein the one or more processors are further configured to:
refrain from receiving the one or more first DMRS ports based on delay information in a QCL type associated with the one or more first reference signals when the one or more first DMRS ports are not delay-related validly QCL'd with the one or more first reference signals.

5. The apparatus of claim 4, wherein the delay information includes average delay or a combination of average delay and delay spread.

6. The apparatus of claim 1, wherein the indication is included in a configuration associated with the PDSCH.

7. The apparatus of claim 6, wherein the indication is associated with all transmit-receive points associated with the PDSCH.

8. The apparatus of claim 1, wherein the indication is included in a transmission configuration indicator (TCI) state associated with the PDSCH.

9. The apparatus of claim 8, wherein the indication is associated with a transmit-receive point associated with the TCI state.

10. The apparatus of claim 1, wherein the frequency compensation is relative to a first transmit-receive point (TRP) of a plurality of TRPs used by the network, and the indication is associated with one or more of the plurality of TRPs excluding the first TRP.

11. The apparatus of claim 1, wherein the frequency compensation is applied to a plurality of transmit-receive points (TRPs) used by the network, and the indication is associated with one or more of the plurality of TRPs.

12. The apparatus of claim 1, wherein the data is received using coherent joint transmission, and the one or more first DMRS ports include all DMRS ports associated with the UE.

13. The apparatus of claim 1, wherein the data is received using non-coherent joint transmission, and the one or more first DMRS ports are included in at least one code division multiplexing (CDM) group.

14. The apparatus of claim 13, wherein the at least one CDM group includes a second CDM group and excludes a first CDM group.

15. The apparatus of claim 13, wherein the at least one CDM group includes a first CDM group and a second CDM group.

16. The apparatus of claim 1, wherein the one or more processors are further configured to:
receive a configuration associated with a sounding reference signal (SRS); and
transmit the SRS based on the configuration,
wherein the indication is based at least in part on the SRS.

17. The apparatus of claim 1, wherein the one or more processors are further configured to:
measure the one or more first reference signals; and
transmit a report based on the measuring,
wherein the indication is based at least in part on the report.

18. An apparatus for wireless communication at a network entity, comprising:
a memory; and
one or more processors, coupled to the memory, configured to:
transmit an indication of whether one or more first demodulation reference signal (DMRS) ports are delay-related validly quasi-co-located (QCL'd) with one or more first reference signals based on frequency compensation performed by the network entity; and
transmit to a user equipment (UE) based on the indication.

19. The apparatus of claim 18, wherein, to transmit to the UE, the one or more processors are configured to:
transmit the one or more first reference signals with the frequency compensation; and
transmit the one or more first DMRS ports with the frequency compensation.

20. The apparatus of claim 18, wherein, to transmit to the UE, the one or more processors are configured to:
transmit the one or more first reference signals without the frequency compensation; and
transmit the one or more first DMRS ports with the frequency compensation.

21. The apparatus of claim 18, wherein the indication is included in a configuration associated with a physical downlink shared channel (PDSCH).

22. The apparatus of claim 21, wherein the indication is associated with all transmit-receive points associated with the PDSCH.

23. The apparatus of claim 18, wherein the indication is included in a transmission configuration indicator (TCI) state.

24. The apparatus of claim 23, wherein the indication is associated with a transmit-receive point associated with the TCI state.

25. The apparatus of claim 18, wherein the frequency compensation is relative to a first transmit-receive point (TRP) of a plurality of TRPs associated with the network entity, and the indication is associated with one or more of the plurality of TRPs excluding the first TRP.

26. The apparatus of claim 18, wherein the frequency compensation is applied to a plurality of transmit-receive points (TRPs) associated with the network entity, and the indication is associated with one or more of the plurality of TRPs.

27. The apparatus of claim 18, wherein, to transmit to the UE, the one or more processors are configured to:
transmit using coherent joint transmission, wherein the one or more first DMRS ports include all DMRS ports associated with the UE.

28. The apparatus of claim 18, wherein, to transmit to the UE, the one or more processors are configured to:
transmit using non-coherent joint transmission, wherein the one or more first DMRS ports are included in at least one code division multiplexing (CDM) group.

29. The apparatus of claim 28, wherein the at least one CDM group includes a second CDM group and excludes a first CDM group.

30. The apparatus of claim 28, wherein the at least one CDM group includes a first CDM group and a second CDM group.

31. The apparatus of claim 18, wherein the one or more processors are further configured to:
transmit a configuration associated with a sounding reference signal (SRS); and
measure the SRS based on the configuration,
wherein the indication is based at least in part on measuring the SRS.

32. The apparatus of claim 18, wherein the one or more processors are further configured to:
transmit the one or more first reference signals; and
receive a report associated with the one or more first reference signals,
wherein the indication is based at least in part on the report.

33. A method of wireless communication performed by a user equipment (UE), comprising:
receiving an indication of whether one or more first demodulation reference signal (DMRS) ports are delay-related validly quasi-co-located (QCL'd) with one or more first reference signals based on frequency compensation performed by a network; and
receiving data on a physical downlink shared channel (PDSCH) based at least in part on the indication.

34. A method of wireless communication performed by a network entity, comprising:
transmitting an indication of whether one or more first demodulation reference signal (DMRS) ports are delay-related validly quasi-co-located (QCL'd) with one or more first reference signals based on frequency compensation performed by the network entity; and
transmitting to a user equipment (UE) based on the indication.
